(19) United States
(12) Patent Application Publication
(10) Pub. No.: US 2011/0287959 A1
(43) Pub. Date: Nov. 24, 2011

(54) PAN-ANTIBODY ASSAYS - PRINCIPLES, METHODS, AND DEVICES

(75) Inventors: Jane F. Emerson, Irvine, CA (US); Emil P. Kartalov, Pasadena, CA (US)

(73) Assignee: UNIVERSITY OF SOUTHERN CALIFORNIA, Los Angeles, CA (US)

(21) Appl. No.: 13/112,754

(22) Filed: May 20, 2011

Related U.S. Application Data
(60) Provisional application No. 61/346,849, filed on May 20, 2010.

(51) Int. Cl. C40B 30/04; C40B 60/12

(52) U.S. Cl. 506/9; 506/39

(57) ABSTRACT

The present invention includes methods, assays, and devices for assaying a sample to detect the presence, absence, or level of at least one analyte in a biological sample using a pan-antibody panel or multiplexed immunoassay, wherein at least one analyte is detected by two or more antibodies. Certain embodiments include the use of a microfluidic device in the immunoassay. Further embodiments of the invention include assays, methods, and devices to detect the presence, absence, or level of at least one analyte which is determined for a diagnostic or a scientific purpose. Still further embodiments of the invention include assays, methods, and devices to detect the presence, absence, or level of at least one analyte which is indicative of a condition or disease. Yet further embodiments of the invention include incorporating additional diagnostic techniques (e.g., PCR, RT-PCR, and DNA hybridization arrays) to the assays, device, and methods.

### CROSS-REFERENCE TO RELATED APPLICATIONS

This application claims the benefit of priority to U.S. Provisional Patent Application Ser. No. 61/346,849 filed 20 May 2010, which is incorporated by reference herein in its entirety.

### STATEMENT REGARDING FEDERALLY-SPONSORED RESEARCH

This invention was made with government support under Contract No. 4R00 EB007151-03 awarded by the National Institutes of Health. The U.S. Government may have certain rights in this invention.

### FIELD OF THE INVENTION

This invention relates to the use of multiplexed immunoassays in microfluidic devices for the detection of an analyte.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Current immunoassays are known to be subject to clinically significant inaccuracies and imprecision. Their limitations can be critical and devastating. Of particular concern are cases in which reliance on immunoassay results lead to highly invasive, harmful and unnecessary clinical interventions. For example, a report in Lancet (1) shows how false positive HCG results by immunoassay led to unwarranted chemotherapy, radiation therapy, hysterectomy and orchiectomy. The reason for the false positive was attributed eventually to immunoassay interference, as the diagnostic result was positive in one assay but negative in another.

The reason for the above problems is a combination of several factors: the basic biological nature of immunoassays; how antibodies are manufactured and tested for quality; how diagnostic immunoassay tests are designed and performed; and how diagnostic results are interpreted and utilized.

In terms of basic biology, immunoassay interference may be due to specific anti-animal antibodies, heterophile antibodies or various non-specific interferents in the patient's serum (2,3). The exact prevalence is unknown but various studies report double-digit false positive or false negative rates (3, 4). Various solutions for addressing the problem have been proposed, however they are cumbersome, labor intensive and typically would not be performed within the normal course of laboratory operations (5).

Other basic problems have to do with activity and longevity. As protein samples deteriorate, a once-calibrated antibody sample can lose activity and thus would tend to produce a smaller signal in response to the same dose of analyte. The result is an underestimation of the expression level of the analyte. Traditional solutions include the discarding of questionable reagents and periodic recalibration to confirm adequate performance. The former is inefficient in terms of use of reagents, while the latter requires time and effort from the laboratory personnel. Thus both are not practiced as often as they should be. To maintain accreditation, clinical labs officially are allowed to use only reagents within the specified expiration dates, so they are far less susceptible to this problem than academic research settings; however, in reality there are the reagent can lose activity prior to the advertised expiration dates. Also, systematic errors, e.g. with refrigeration procedures can also occur.

In terms of manufacturing and quality control, antibody suppliers test different production batches against a calibrated sample of commercially available analog to the diagnostic analyte, and compare the results to select the best-performing antibody. Then the best-performing antibody is treated typically as though it has a 99% or 100% “activity” or “specificity” and is sold as the winning batch as a “good” antibody. The problem with this is that testing conditions are specific to the protocol and system used by the manufacturer for quality control, which allows for variable performance in either scientific or diagnostic laboratories. In addition, the commercial analog used for defining the assays may be a poor model for the human analyte for particular patients or situations, e.g. due to fundamental biological variability.

In terms of the way immunoassays are used, researchers and clinical assay vendors generally select one “good” antibody from the manufacturer with the expectation that diagnostic performance will be adequate in measurement systems. This is the current standard of practice in cost effectiveness. If assay performance is found to be less than acceptable, the assay reagents, including the basic capture antibody are reformulated. High costs, including indirect costs of inaccurate diagnoses and assay recalls are associated with this process. This is a common and wide-spread problem, which has been treated as normal in immunoassays and thus has been left largely ignored and unaddressed.

In terms of diagnostic results, interference and the rest of the problems mentioned above are not treated proactively under the current standard of care. Interference in a particular patient specimen is an unpredictable event, leaving clinicians and clinical laboratory personnel to troubleshoot only when the laboratory result is in conflict with the clinical picture. However, this approach is inherently problematic, as increasingly, medical decisions and the clinical picture itself are based on laboratory results.

Therefore, there is significant need in the art for a new immunoassay technology that can address and correct the array of problems that currently exist in the practice of immunoassays for clinicians and scientist. In summary, the array of problems include: the basic biological nature of immunoassays; how antibodies are manufactured and tested for quality; how diagnostic immunoassay tests are designed and performed; and how diagnostic results are interpreted and utilized.

### SUMMARY OF THE INVENTION

The following embodiments and aspects thereof are described and illustrated in conjunction with compositions and methods are meant to be exemplary and illustrative, not limiting in scope.

The present invention provides for methods, assays, and devices for assaying a sample to detect a presence, absence, or level of at least one analyte using a pan-antibody panel or multiplexed immunoassay.

Various embodiments provide for an assay to detect a presence, absence, or level of at least one analyte in a biological sample comprising the use of a pan-antibody panel or multiplexed immunoassay, wherein at least one analyte is detected by two or more antibodies. Various further embodiments provide for an assay wherein the assay comprises the use of a microfluidic device. Certain embodiments provide for an assay wherein the presence, absence or level of at least one analyte is determined for a diagnostic or a scientific purpose.

Further embodiments provide for the assay detecting the presence, absence, or level of at least one analyte is indicative of a condition or disease. Still further embodiments provide the condition or disease be selected from cancer, cardiac disease, endocrine disease, brain disease, reproductive disease, infectious disease including viruses, prions, bacteria, fungi, yeast, autoimmune disease, chronic inflammation, pregnancy, mental conditions or disorders, physical conditions or disorders, metabolic conditions or disorders, genetic conditions or disorders, and allergic conditions or disorders.

Certain embodiments provide for the pan-antibody panel or multiplexed immunoassay to include two or more antibodies for each analyte. Further certain embodiments provide for the pan-antibody panel or multiplexed immunoassay to include two or more antibodies for each analyte, wherein the two or more antibodies can be used to conduct a sandwich immunoassay. Further embodiments provide for the pan-antibody panel or multiplexed immunoassay including two or more concentration or dose levels for each antibody used. Still further embodiments provide for the pan-antibody panel or multiplexed immunoassay including an ability to test for two or more analytes in the same assay with multiple antibodies to at least one analyte and an independently measured result for each antibody. Yet further embodiments provide for the pan-antibody panel or multiplexed immunoassay including a pretreatment by heterophile blocking reagents.

According to certain embodiments, the pan-antibody panel or multiplexed immunoassay includes a specific anti-animal antibody, wherein the specific anti-animal antibody identifies false positives. According to further embodiments, the pan-antibody panel or multiplexed immunoassay further comprises interpretive algorithms and/or an additional diagnostic technique. According to further embodiments, the additional diagnostic technique is selected from the group consisting of PCR, RT-PCR, and DNA hybridization arrays.

In various embodiments, a device is disclosed for detecting a presence, an absence or a level of at least one analyte in a biological sample comprising a pan-antibody panel or multiplexed immunoassay, wherein the pan-antibody panel or multiplexed immunoassay utilizes a reagent (e.g. one of antibodies or antigens) immobilized to a matrix and wherein the device comprises a microfluidic device.

The present invention also provides a method of assaying for a presence, an absence or a level of at least one analyte in a sample comprising obtaining a biological sample, assaying the biological sample to determine a presence, an absence or a level of at least one analyte, wherein a pan-antibody panel or multiplexed immunoassay is used, and wherein at least one analyte is detected by two or more antibodies.

The present invention also provides for a kit for assaying for a presence an absence, or a level of at least one analyte in a sample; comprising: a device capable of assaying the presence, absence, or level of at least one analyte in a sample: wherein the device comprises an pan-antibody panel or multiplexed immunoassay; and instructions to use.

Other features and advantages of the invention will become apparent from the following detailed description, which illustrate, by way of example, various features of embodiments of the invention.

### BRIEF DESCRIPTION OF THE DRAWINGS

Exemplary embodiments are illustrated in referenced figures. It is intended that the embodiments and figures disclosed herein are considered illustrative rather than restrictive.

FIG. 1 depicts a basic architecture for a microfluidic device, where the channels are represented by dark thick lines in top view and differing antibody concentrations are represented by progressively darker shading.

FIG. 2 depicts an embodiment of the two-dimensional chip or superarray, which shows a single-analyte test matrix for the 3-by-2 case, i.e. one in which there are three “top” antibodies and two “bottom” antibodies against the same antigen.

FIG. 3 depicts an embodiment of the three-dimensional chip, wherein the arrangement (array) represents a 3-by-2 geometry for analyte A and a 2-by-1 geometry for analyte B.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. Singleton et al., Dictionary of Microbiology and Molecular Biology 3^{rd} ed., J. Wiley & Sons (New York, N.Y. 2001); March, Advanced Organic Chemistry Reactions, Mechanisms and Structure 5^{th} ed., J. Wiley & Sons (New York, N.Y. 2001); and Sambrook and Russell, Molecular Cloning: A Laboratory Manual 3rd ed., Cold Spring Harbor Laboratory Press (Cold Spring Harbor, N.Y. 2001), provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

Certain embodiments disclosed herein relate to providing devices, assays, and methods of assaying a sample to detect a presence or absence of an analyte using a pan-antibody panel or multiplexed immunoassay. Further embodiments relate to the use of a microfluidic device in the practice of the current invention. In certain specific embodiments, the presence or absence of an analyte is indicative of a disease or condition (e.g autoimmune disease, chronic inflammation, pregnancy, mental conditions or disorders, physical conditions or disorders, metabolic conditions or disorders, genetic conditions or disorders, allergy and infectious disease.).

In further specific embodiments, the pan-antibody panel or multiplexed immunoassay includes two or more antibodies for each analyte, two or more concentration levels for each antibody used, an ability to test for two or more analytes in the same assay, pretreatment by heterophile blocking reagents, and/or specific anti-animal antibodies.

Certain embodiments disclosed herein relate to techniques and methods using novel microfluidics technology that provides obtaining more complete data, minimizes known metrological problems as discussed above, cancels out the influence of systematic effects, and allows for the study of those effects to improve test panels. The novel technology disclosed herein is advantageous because the technology uses multiple small-volume assay chambers within one assay.

In certain specific embodiments, the novel pan-antibody technology disclosed herein incorporates multiple antibodies into one immunoassay panel for each analyte, which improves the sensitivity and specificity of the assay. This pan-antibody approach allows for detecting and characterizing an analyte by a panel of antibodies rather than relying on only one antibody. In further specific embodiments, the novel pan-antibody technology disclosed herein incorporates varying concentrations of antibodies into one assay panel which allows for extremes of analyte concentrations, further reducing potential sources of error. In yet further specific embodiments, the novel pan-antibody technology disclosed herein incorporates pretreatment by heterophile blocking reagents into immunoassays. In still further specific embodiments, the novel pan-antibody technology disclosed herein incorporates specific anti-animal antibody testing to screen for false positives.

In certain specific embodiments, the novel pan-antibody technology disclosed herein incorporates interpretive algorithms based on results from the varyingly constructed chambers to determine the presence of interference. In further specific embodiments, the novel pan-antibody technology disclosed herein incorporates antibodies recognizing different analytes for multi-test panels without using higher volumes of patient samples. This allows for more efficient assaying of a patient sample. In still further specific embodiments, the novel pan-antibody technology disclosed herein combines pan-antibody approaches discussed above with other diagnostic techniques, e.g. PCR, RT-PCR, and DNA hybridization arrays, as confirmation tools, or as an integral test, e.g. for cross-species reactivity and future gene-therapy patients. In further specific embodiments, the novel pan-antibody technology disclosed herein utilizes specific microfluidic architectures.

According to certain embodiments, the inventive assay improves immunological assay performance. In addition, the novel pan-antibody technology disclosed herein improves cost effectiveness and laboratory operations for clinical applications requiring the simultaneous measurement of a number of analytes while minimizing the volume of blood required. According to certain embodiments, panels can test for several biological conditions, disorder and/or disease states. Including but not limited to autoimmune disease, chronic inflammation, pregnancy, mental conditions or disorders, physical conditions or disorders, metabolic conditions or disorders, genetic conditions or disorders, allergy and infectious disease.

### Pan-Antibody Panel: Multiplexed Immunoassay

“Pan-antibody panel” or “multiplexed immunoassay” as used herein refers to an immunoassay that contains at least one type of detecting reagent. Detecting reagents can include but are not limited to antigens, proteins, immunological proteins, antibodies, or any portion thereof.

“Immunoassay” as used herein refers to a biochemical test that measures the presence or concentration of a substance in solutions that frequently contain a complex mixture of substances. Such assays are based on the unique ability of an antibody to bind with high specificity to one or a very limited group of molecules. Immunoassays can be conducted for either member of an antigen/antibody pair. For antigen analytes, an antibody that specifically binds to that antigen can frequently be prepared for use as an analytical reagent. When the analyte is a specific antibody its cognate antigen can be used as the analytical reagent. In either case the specificity of the assay depends on the degree to which the analytical reagent is able to bind to its specific binding partner to the exclusion of all other substances that might be present in the sample to be analyzed. In addition to the need for specificity, a binding partner must be selected that has a sufficiently high affinity for the analyte to permit an accurate measurement. The affinity requirements depend on the particular assay format that is utilized.

### Microfluidic Device

“Microfluidic device” as used herein refers to a device or instrument that uses very small amounts of fluid on a microchip to perform tests (e.g. laboratory tests).

### Analyte

“Analyte” as used herein refers to a substance undergoing analysis. Analytes include but are not limited to antigens, proteins, biomarkers, antibodies, or any portion thereof. The analyte will be contained often within a biological sample.

### Reagents

Reagents as used herein refer to a substance that can detect the presence of an analyte. Reagents include but it is not limited to antibodies or antigens.

### Biological Sample

“Biological sample” as used herein refers to a sample derived from a biological source, including but not limited to urine, whole blood, semen, serum, plasma, cerebrospinal fluid, sweat, and saliva.

### Condition, Disorder, or Disease

“Condition, disorder, or disease” as used herein refers to an abnormal or altered condition affecting the body of an organism. Diseases can be classified as pathogenic disease, deficiency disease, hereditary disease, and physiological disease. Diseases also can be classified as communicable and non-communicable disease

Some examples of diseases and conditions include, but are in no way limited to, cancer, cardiac disease, endocrine disease, brain disease, reproductive disease, infectious disease including viruses, prions, bacteria, fungi, yeast, autoimmune disease, chronic inflammation, pregnancy, mental conditions or disorders, physical conditions or disorders, metabolic conditions or disorders, genetic conditions or disorders, and allergic conditions or disorders.

### Biomarkers

As apparent to one of skill in the art, any number of biomarkers may be used in conjunction with various embodiments described herein. Some examples of biomarkers include, but are not limited to, polypeptides, antigens such as glycosylated subunits and lipids, and polynucleotides including microRNA, microsatellite DNA, SNPs, and both genetic and epigenetic. Similarly, as apparent to one of skill in the art, the various embodiments described herein may be used to detect any number of diseases and conditions.

Combination with Other Types of Analysis

According to certain embodiments, the novel pan-antibody technology disclosed herein can be combined with other types of diagnostic confirmation techniques, including but not limited to PCR, RT-PCR, and DNA hybridization arrays.

### Pan-Antibody Technology

According to certain embodiments, the novel pan-antibody technology disclosed herein includes but is not limited to antibody titration in parallel measurements. In particular, a technique is disclosed, wherein every antibody is present in multiple test copies at different dosimetry with respect to the analyte. For example, aliquots of the same sample would be exposed to different amounts of antibody, resulting in different density of binding. Varying the antibody amount shifts the dynamic range of the test along the axis of analyte concentration. As a result, the combined set of multiple tests of the same antigen-antibody pair will produce some false-negative, some saturation, and some legitimate results. The overall test is more robust against these threats, because its effective cumulative dynamic range is expanded, and the test is far more likely to perform well with diagnostic outliers. Hence, the disclosed technique is stronger and works with a wider group of samples when compared to the traditional methods, which improves diagnostic reliability and related medical outcomes.

According to certain embodiments, the novel pan-antibody technology disclosed herein includes but is not limited to utilizing multiple antibodies to detect the same analyte. In particular, a technique based on simultaneous measurements of the same antigen against multiple different antibodies is performed in the same device and on the same sample, the result of each measurement is obtained and reported separately. This method ensures that systematic errors are minimized, while differences in the results can be attributable solely to differences in the performances of the antibodies. In addition, quantitative comparison among the results reveals metrological insights that would be inaccessible otherwise. For example, if the set of measurements reports widely varying results, all measurements are put in question and the danger of a medical decision based on potentially wrong results is avoided. Conversely, if the results are in essential agreement, then they are that much more trustworthy and actionable. Finally, if most results essentially agree, while a few results widely disagree, the indication would be that there is interference or failure in the one or two abnormal results.

For certain applications, such as in diagnosing autoimmune disease, differences in reactivity with different antibodies may add to the overall diagnostic sensitivity and specificity of the assay.

According to certain embodiments, the novel pan-antibody technology disclosed herein includes but is not limited the use of heterophile blocking. Heterophile blocking reagents are incorporated as needed in the above schemes, to allow for the possibility of heterophilic antibodies in the patient serum cross-reacting with assay antibodies thereby causing false positives [6].

According to certain embodiments, the novel pan-antibody technology disclosed herein includes but is not limited the use of assays formulated with animal antibodies. Because some patients make specific anti-animal antibodies due to previous exposure either passively or therapeutically, assays formulated with animal antibodies are prone to exhibit both false positives and false negatives [7]. To reduce these errors device chambers can include testing for specific anti-animal antibodies, in particular human anti-mouse antibodies (HAMA). A positive result to this portion of the composite assay indicates the presence of interference and serves as an alert to the likelihood of erroneous results.

In addition, the pan-antibody panels can include antibodies against the same analyte but produced in different animal systems, to allow for confirmatory comparisons. For example, the panel may contain antibodies from mouse and from goat at the same time. Receiving disparate estimates from the two would indicate the presence of interference effects, while agreeing estimates would attest to the reliability of the finding.

According to certain embodiments, the novel pan-antibody technology disclosed herein can include a combination of the above-described techniques that can be organically combined within the same device and/or experiment on the same sample for multiple analytes. Each analyte can be tested in chambers containing an antibody or panels of antibodies against it. Each such antibody would have a collection of parallel tests, wherein it is present in different stoichiometric ratios to the supplied antigen. Each test would be reported separately, allowing for the selection of the most meaningful result for each antigen-antibody combination, e.g. through considerations of dynamic range. Then each meaningful result would be compared to the others from the other antigen-antibody combinations, for the same antigen. This in turn produces full diagnostic information for each analyte. The information can be correlated among multiple analytes on the same diagnostic panel, and also compared with the simultaneous quality-control or reliability tests judging cross-species effects, etc.

According to certain embodiments, the novel pan-antibody technology disclosed herein and the techniques described above can be multiplexed and performed in the same diagnostic and/or analytical device, owing to the miniaturization and parallelization capabilities of modern microfluidic technology [8]. Two-dimensional test matrices have been shown, in which parallel tests are arranged along one axis, while the other accommodates multiple samples [9] or aliquots of the same sample, which have been modified in some way [10,11].

In one embodiment of the above ideas, the test matrix can be arranged so that each row on the chip corresponds to a particular case of antibody at a specific titration amount, in the absence or presence of additional modifiers, e.g. heterophile blocking agents. According to further embodiments, the agents are either present or absent and two rows per antibody at a specific titration are used. If there are five titration concentrations per antibody, there will be five pairs of such rows, or 10 rows per antibody. If each analyte would be characterized simultaneously against 5 antibodies, there will be 50 rows per analyte. If the device is to service a panel of 5 analytes, this means it will have 250 rows for antibodies. Such devices can be made according to current technology, e.g. [7, 11].

Along the perpendicular axis, columns will be arranged to accommodate a sample or samples. In one embodiment, the same starting sample can be fluidically titrated to different dosimetry in each column. For example, each column can be made somewhat wider than its preceding neighbor, decreasing the fluidic resistance, increasing throughput, increasing the volume of sample supplied, and thus increasing the amount of antigen provided for binding (over the same experimental time period and at the same applied pressure).

In another embodiment, the sample can be similarly titrated by chemical means. For example, the geometry can be kept the same along the columns axis within the test matrix, but each column can receive a varying amount of dilutant, e.g. by mixing with buffer.

In another embodiment, multiple samples can be tested in the same device by feeding each sample in its own column, in parallel.

In another embodiment, multiple samples can be arranged within the same device to be tested in parallel, wherein each sample is titrated by any of the above techniques in its own subspace of the test matrix. For example, if each sample is titrated to 5 different dosimetry settings, it would take 5 columns to accommodate it on the device. Furthermore, each titrate can be measured in duplicate, requiring two independent measurements and thus requiring 10 columns total per sample. If 10 samples are to be processed on the same device, it would take 100 columns to accommodate this arrangement. Such devices can be made according to current technology, e.g. [7, 12].

The above techniques are generally independent of the chosen method of detection and quantification. Fluorescence immunoassay techniques have been demonstrated [9-11] for such diagnostic purposes, and would be applicable with the new methodologies as well. However, the applicability is not limited to fluorescence. The methods can also be chemi-luminescence, radioactive labeling, electrochemical measurements [13], ELISA, microspheres [14, 15], photonic resonance biosensors [16], as well as any other method that can be incorporated with or integrated into microfluidic devices.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### Basic Architecture for Antibody Titration and Internal Recalibration

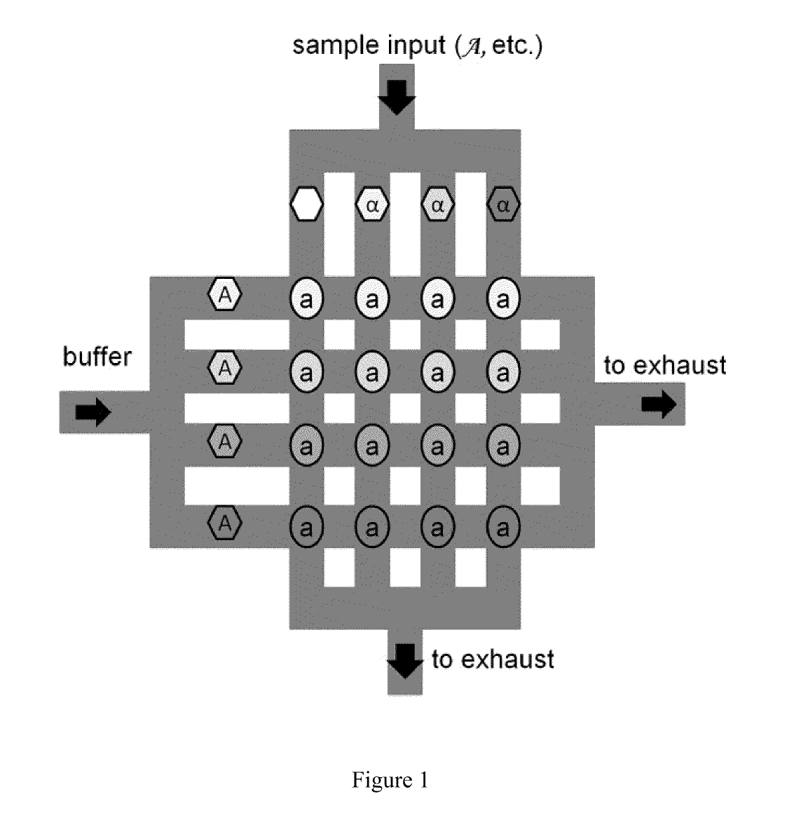

In this Example and as described above, a particular antibody was titrated for the purpose of widening the effective dynamic range of the immunoassay measurement. FIG. 1 shows a particular geometry to accomplish this. It depicts a microfluidic device, wherein the channels are represented by dark thick lines in top view. In the particular device, antibody “a” was chemically bound (e.g. covalently bonded [9-11]) to the bottom surface of the channel, and then lyophilized in place. The respective bonding locations are represented by circles with black rims. Different locations received different amounts of bound antibody, wherein that variation is represented by varying tint of the inside area of the circles, e.g. darker tint corresponding to larger amount.

In addition, FIG. 1 also depicts a second antibody, “A”, against the same antigen “A”, which was also present in the system, so that sandwich immunoassays were constructed as described below. The antibody A was not chemically bonded to the surface of the channels but was deposited in lyophilized form or lyophilized in place. That state is represented by a hexagon, to distinguish it from the bonded state of the antibody “a”. As before, the amount of A was varied at different locations to produce a titration.

Note that the matrix of “A” vs “a” was arranged in such a way that the amounts of the two correlate. According to certain embodiments, this correlation was included to allow for the optimal performance of the sandwich immunoassay, which presupposes a relationship between the two. That relationship does not have to be equal, since the second antibody is often used in excess, to ensure maximal second binding. However, general correlation is appropriate in setting up the respective dynamic ranges. For example, “A” must always be equal or more than “a”, to ensure that all bound antigen is accounted for by the sandwich immunoassay. However, if “A” is in great excess to “a”, the results could be skewed, because there will be diminishing returns in signal paired with an increase in noise, e.g. from non-specific attachment. Thus the figure represents “A” and “a” as roughly correlating in amount.

FIG. 1 also shows lyophilized amounts of “a” (“alpha”), which is an analog to the analyte of interest “A”. The analog was deposited lyophilized but not chemically bonded to the channel surface, ergo the use of a hexagon to denote the locations, according to the convention introduced above. Here, the amounts were titrated, to allow for the use of the method of internal recalibration [10, 11]. Note that, accordingly, one of the channels contained no analog “a”, so that the respective results corresponded to unspiked sample, which was necessary data for the recalibration scheme.

The diagram does not show the sets of vertical and horizontal microfluidic valves, which restrict the flow in the test matrix to vertical parallel isolated channels or horizontal parallel isolated channels. This is done to make the diagram more easily readable, while the presence of the valves is understood by the intended operation, and they are arranged, for example, as in [9-11], which are incorporated by reference in their entirety. In another embodiment, there can be a design in which the use of valves is somehow circumvented, e.g. by making the channel separations long enough. It is understood that the proposed method would also cover such contingencies.

### Example 2

### Operation of the Device

In a typical operation of the device shown in FIG. 1, first the flow is allowed along the vertical channels and disallowed along the horizontal channels in the diagram, e.g. by use of microfluidic valve arrays [9-11]. Then, sample is fed into it from the top of the diagram, e.g. by static pressure or capillary action. The sample contains an analyte of interest—the antigen “A”. The sample re-suspends the respective amounts of analog and thus is spiked to varying concentrations of analog. The respective resulting subsamples are isolated from one another along the horizontal axis, so there is no cross-talk horizontally. The antigen “A” and its analog “a” bind to the antibody “a”, as the rest of the sample flows into the exhaust at the bottom of the diagram.

Next, flow is allowed along the horizontal channels but disallowed along the vertical channels, e.g. by the same means of microfluidic valve arrays. Buffer is fed from the left side of the diagram, e.g. by static pressure or capillary action. The buffer re-suspends the second antibody A, and the respective subsamples wash over the capture areas defined by bonded antibody “a” inside the test matrix. Vertical restriction ensured that no cross-talk occurs among adjacent horizontal channels. The antibody A binds to the captured analyte and captured analog, to complete the sandwich immunoassay. As the buffer feed continues, all unbound excess of antibody A is washed away. The system is subjected then to detection and quantification.

After detection is performed at every capture location, the results are analyzed according to the recalibration method [10, 11], i.e. a linear fit to a plot of signal versus spiking-concentration is done for every row in the matrix, the slope is calculated, and the zero-spike signal is divided by the slope to reveal the endogenous concentration of the analyte.

Note that the described method is independent of the chosen detection method, which may be based on radioactive, fluorescent, chemi-luminescent, enzymatic, or electrochemical labeling, as some examples, or on even label-free techniques [16]. According to certain embodiments, the novel pan-antibody technology can also be used to multiplex the analog.

Also note that the described techniques are independent of the type of sample input, which can be serum, plasma, cerebrospinal fluid, sweat, saliva, etc. It can also be devised that untreated samples, e.g. whole blood, are first fed into a sample-preparation pre-stage, which produces a processed output that becomes the input of the proposed device.

### Example 3

### Multiplexed Architecture for Immunoassays

Example 1 describes the use of the novel pan-antibody technology having a single analyte, a single analog, and a single pair of bottom and top antibodies. This Example 3 discloses and describes the multiplexing of antibodies and multiplexing tests for both the same and different analytes on the same sample.

In Example 1 the experimental block was denoted by {A, a, A, a}. In this Example 3 multiple antibodies against the same analyte re used, “A” and “a” become variables that can be indexed, for example {Aᵢ, aⱼ}. Each index then denotes a different antibody of the same type and intended function. For example, A₃ and A₇ are both “top” antibodies against antigen A, but they are not identical.

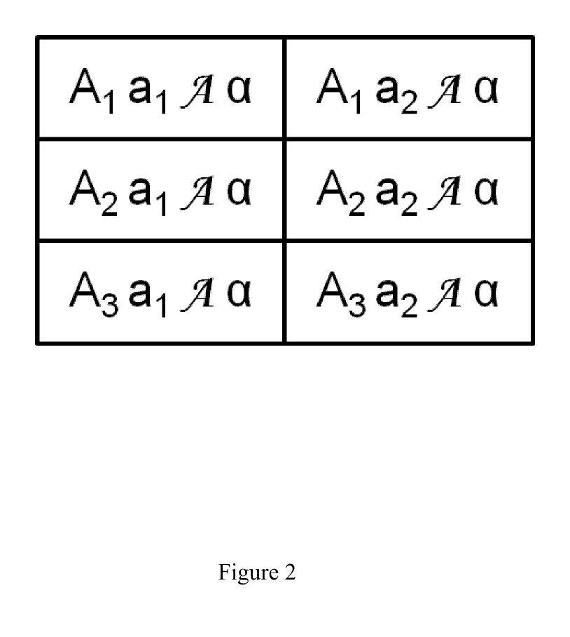

Such indexing produces independent experimental blocks of the type {Aᵢ, aⱼ, A, a}. These can be arranged in a two-dimensional i-by-j array, which map directly into the physical test matrix of the microfluidic device, e.g. using the “block” architecture in the previous example. FIG. 2 shows an embodiment of the superarray could look like for the 3-by-2 case, i.e. one in which there were three “top” antibodies and two “bottom” antibodies against the same antigen.

When multiple antigens are present, the above superarray can be copied and arrayed again. This is accomplished in different ways. One method is to have a three-dimensional chip, where each layer, or “floor”, services a different analyte. Here all floors are connected in parallel to a single input source, to allow the initial sample to be split into multiple subsamples, each of which then are used for the test against a particular analyte on its own “floor”.

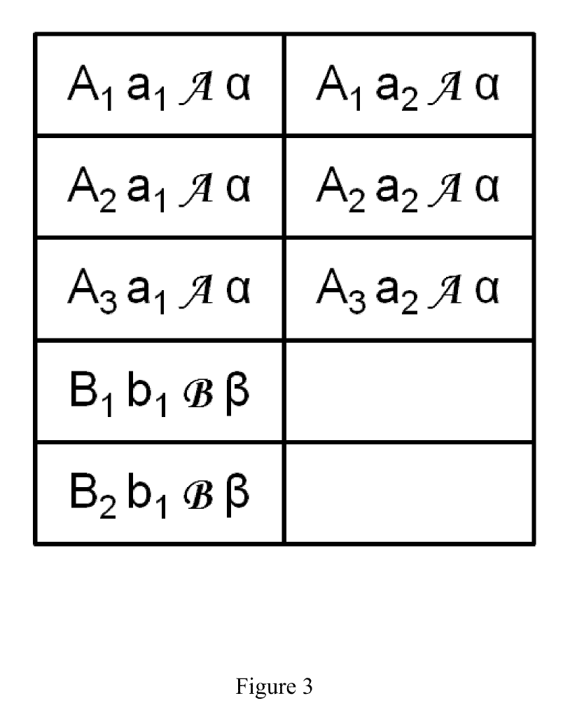

Another method is to construct a larger two-dimensional chip, where the arrays are positioned in the plane. One embodiment of that geometry is shown in FIG. 3, which depicts a 3-by-2 case for analyte A and a 2-by-1 case for analyte B.

As the sample is fed vertically down the microfluidic device (on the diagram from top to bottom), the same sample is used for the measurements of both analytes. Also, as the re-suspending buffer is fed horizontally (on the diagram from the left side to the right side), antibodies A, are only fed to aⱼ sites, while antibodies Bₘ are only fed to bₙ, sites. This architecture prevents noise from cross-talk between antibodies to different antigens, and thus improves the quality of the results.

According to certain embodiments the inventive pan-antibody technique disclosed in this example is design specifically to show the problems and solutions related to situations where the dimensions for the different antigen testing blocks do not match. Clearly, “i” and “m” are independent and do not result in problems, but when j n, the empty blocks are a problem. One solution is to replicate the fluidic architecture of a functional block but not include antibodies and analog samples. This solution allows for the respective subsamples to pass through unimpeded and unchanged to the blocks of the next analyte.

According to certain embodiments, the analog lyophilates disclosed in the current invention are not required to be introduced at the beginning of every block even within a large panel dedicated to the same analyte. As such, one embodiment of the current invention re-introduces the analyte with appropriate spatial periodicity within the device, while another embodiment introduces the analyte once at the beginning of the device.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

### 1. REFERENCES

[1] Rotmensch S, Cole L A (2000) False diagnosis and needless therapy of presumed malignant disease in women with false-positive human chorionic gonadotropin concentrations. Lancet 355:712-5.
[2] Kricka L J, (2000) Interferences in immunoassay—still a threat [Editorial] Clin Chem 46:1037-8.
[3] Kricka L J, (1999) Human anti-animal interferences in immunological assays. Clin Chem 45:942-56
[4] Hennig C, et al. (2000) The influence of naturally occurring heterophilic anti-immunoglobulin antibodies on direct measurement of serum proteins using sandwich ELISAs. J Immun Methods 235:71-80.
[5] Emerson J F, Ngo G, Emerson S S. (2003) Screening for interference in immunoassays. Clin Chem 49:7 1163-9.
[6] Butler S A, Cole L A (2001) Use of heterophilic antibody blocking agent (HBT) in reducing false-positive hCG results. Clin Chem 47:1332-3.
[7] Reinsberg J. (1998) Interference with two-site immunoassays by human anti-mouse antibodies formed by patients treated with monoclonal antibodies: comparison of different blocking reagents. Clin Chem 44:1742-4.
[8] Kartalov, E. P., Anderson, W. F., and Scherer, A. (2006) The Analytical Approach to PDMS Microfluidic Technology and Its Biological Applications. J. Nanoscience &Nanotechnology, 6:8, 2265-2277.
[9] Kartalov, E. P., Zhong, J., Scherer, A., Quake, S., Taylor, C. and Anderson, W. F. (2006) High-Throughput Multi-Antigen Microfluidic Fluorescence Immunoassays. BioTechniques 40:1, 85-90.
[10] Kartalov, E. P., Lin, D. H., Lee, D. T., Anderson, W. F., Taylor, C. R., and Scherer, A. (2008) Internally Calibrated Quantitations of Protein Analytes in Human Serum by Fluorescence Immunoassays in Disposable Elastomeric Microfluidic Devices, Electrophoresis, 29, 5010-5016.
[11] Lin, D. H., Taylor, C. R., Anderson, W. F., Scherer, A., Kartalov, E. P. (2009) Internally calibrated quantification of VEGF in human plasma by fluorescence immunoassays in disposable elastomeric microfluidic devices, J Chromatogr B, 878, 258-263.
[12] Thorsen, T., Maerkl, S. J., Quake, S. R. (2002) Microfluidic Large-Scale Integration, Science 298, 580-584.
[13] Gau V. et al, (2005) Electrochemical molecular analysis without nucleic acid amplification. Methods, 37:1, 73-83,
[14] Diercks A. et al. (2009) A microfluidic device for multiplexed protein detection in nano-liter volumes. Anal. Biochem. 386:1, 30-35.
[15] Kartalov E. P., Taylor C. R., Scherer A. U.S. provisional patent application 61/170,031 (Caltech docket P553-US).
[16] Armani A. et al. (2007) Label-Free, Single-Molecule Detection with Optical Microcavities. Science, 317, 783-787.
[17] Kartalov E. P., Taylor, C. R., Scherer, A. U.S. provisional patent application 61/209,531 (Caltech docket P510-US).

What is claimed is:

1. An assay to detect a presence, an absence, or a level of at least one analyte in a biological sample comprising the use of a pan-antibody panel or multiplexed immunoassay, wherein at least one analyte is detected by two or more antibodies.

2. The assay of claim 1, wherein the assay comprises the use of a microfluidic device.

3. The assay of claim 1, wherein the presence, absence or level of at least one analyte is determined for a diagnostic or a scientific purpose.

4. The assay of claim 1, wherein the presence, absence or level of at least one analyte is indicative of a condition, disorder, or disease.

5. The assay of claim 4, wherein the condition, disorder, or disease is selected from cancer, cardiac disease, endocrine disease, brain disease, reproductive disease, infectious disease including viruses, prions, bacteria, fungi, yeast, autoimmune disease, chronic inflammation, pregnancy, mental conditions or disorders, physical conditions or disorders, metabolic conditions or disorders, genetic conditions or disorders, and allergic conditions or disorders.

6. The assay of claim 1, wherein the pan-antibody panel or multiplexed immunoassay includes two or more antibodies for each analyte.

7. The assay of claim 1, wherein the pan-antibody panel or multiplexed immunoassay includes two or more concentration or dose levels for each antibody used.

8. The assay of claim 1, wherein the pan-antibody panel or multiplexed immunoassay includes an ability to test for two or more analytes in the same assay, with multiple antibodies to at least one analyte and an independently measured result for each antibody.

9. The assay of claim 1, wherein the pan-antibody panel or multiplexed immunoassay includes a pretreatment by heterophile blocking reagents.

10. The assay of claim 1, wherein the pan-antibody panel or multiplexed immunoassay includes a specific anti-animal antibody, wherein the specific anti-animal antibody identifies false positives.

11. The assay of claim 1, further comprising an additional diagnostic technique.

12. The assay of claim 11, wherein the additional diagnostic technique is selected from the group consisting of PCR, RT-PCR, and DNA hybridization arrays.

13. A device for detecting a presence, an absence or a level of at least one analyte in a biological sample comprising a pan-antibody panel or multiplexed immunoassay, wherein at least one analyte is detected by two or more antibodies.

14. The device of claim 13, wherein the device comprises a microfluidic device.

15. The device of claim 13, wherein the device is used for a diagnostic or a scientific purpose.

16. The device of claim 13, wherein the presence, absence, or level of at least one analyte is indicative of a condition, disorder, or disease.

17. The device of claim 13, wherein the condition, disorder or disease is selected from cancer, cardiac disease, endocrine disease, brain disease, reproductive disease, infectious disease including viruses, prions, bacteria, fungi, yeast, autoimmune disease, chronic inflammation, pregnancy, mental conditions or disorders, physical conditions or disorders, metabolic conditions or disorders, genetic conditions or disorders, and allergic conditions or disorders.

18. The device of claim 13, wherein the pan-antibody panel or multiplexed immunoassay includes two or more antibodies for each analyte.

19. The device of claim 13, wherein the pan-antibody panel or multiplexed immunoassay includes two or more concentration or dose levels for each antibody used.

20. The device of claim 13, wherein the pan-antibody panel or multiplexed immunoassay includes an ability to test for two or more analytes in the same assay with multiple antibodies to at least one analyte and an independently measured result for each antibody.

21. The device of claim 13, wherein the pan-antibody panel or multiplexed immunoassay includes a pretreatment by heterophile blocking reagents.

22. The device of claim 13, wherein the pan-antibody panel or multiplexed immunoassay includes a specific anti-animal antibody, wherein the specific anti-animal antibody identifies false positives.

23. The device of claim 13, further comprising an additional diagnostic technique.

24. The device of claim 23, wherein the additional diagnostic technique is selected from the group consisting of PCR, RT-PCR, and DNA hybridization arrays.

25. A method of assaying for a presence, an absence, or a level of at least one analyte in a biological sample comprising
obtaining a biological sample; and
assaying the biological sample to determine a presence, an absence, or a level of at least one analyte, wherein a pan-antibody panel or multiplexed immunoassay is used, and wherein at least one analyte is detected by two or more antibodies.

26. The method of claim 25, wherein the method comprises the use of a microfluidic device.

27. The method of claim 25, wherein the method is a diagnostic or a scientific method.

28. The method of claim 25, wherein the presence, absence, or level of at least one analyte is indicative of a condition or disease.

29. The method of claim 28, wherein the condition or disease is selected from cancer, cardiac disease, endocrine disease, brain disease, reproductive disease, infectious disease including viruses, prions, bacteria, fungi, yeast, autoimmune disease, chronic inflammation, pregnancy, mental conditions or disorders, physical conditions or disorders, metabolic conditions or disorders, genetic conditions or disorders, and allergic conditions or disorders.

30. The method of claim 25, wherein the pan-antibody panel or multiplexed immunoassay includes two or more antibodies for each analyte.

31. The method of claim 25, wherein the pan-antibody panel or multiplexed immunoassay includes two or more concentration or dose levels for each antibody used.

32. The method of claim 25, wherein the pan-antibody panel or multiplexed immunoassay includes an ability to test for two or more analytes in the same assay with multiple antibodies to at least one analyte and an independently measured result for each antibody

33. The method of claim 25, wherein the pan-antibody panel or multiplexed immunoassay includes a pretreatment by heterophile blocking reagents.

34. The method of claim 25, further comprising an additional diagnostic technique.

35. The method of claim 34, wherein the additional diagnostic technique is selected from the group consisting of PCR, RT-PCR, and DNA hybridization arrays.
